(19) United States
(12) Patent Application Publication
(10) Pub. No.: US 2007/0041644 A1
(43) Pub. Date: Feb. 22, 2007

(54) Apparatus and method for estimating a facial pose and a face recognition system using the method

(75) Inventors: Jung-bae Kim, Yongin-si (KR); Seok-cheol Kee, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/455,705

(22) Filed: Jun. 20, 2006

(30) Foreign Application Priority Data
Aug. 17, 2005 (KR) 10-2005-0075297

(51) Int. Cl. G06K 9/46

(52) U.S. Cl. 382/190

(57) ABSTRACT

An apparatus for estimating a facial pose. The apparatus includes a pre-processing module that provides feature points of a subject's face of a received image, and a pose-estimation module that computes sizes of a left half plane and a right half plane of the face from the provided feature points, and a lateral rotation angle of the face from the computed sizes.

### CROSS-REFERENCE TO RELATED APPLICATION

This application claims priority from Korean Patent Application No. 10-2005-0075297 filed on Aug. 17, 2005, the disclosure of which is incorporated herein by reference.

### BACKGROUND OF THE INVENTION

1. Field of the Invention

The present invention relates to estimating a facial pose, and, more particularly, to an apparatus and a method for estimating a facial pose by estimating a lateral rotation angle of a subject's face employing the size ratio of a left half plane to a right half plane of the face based on features points thereof.

2. Description of Related Art

In line with the technological development of semiconductors and image processing, mobile phones and image-capturing devices (hereinafter, referred to as a “portable image-capturing device”), in which an image capturing function has been added to portable devices such as digital cameras, camcorders, and even portable telecommunication devices such as mobile phones, are in widespread use. Such portable image capturing devices provide a moving-picture function to capture moving pictures as well as a still-picture function to capture portraits.

Technology to recognize a face captured by such portable image capturing devices or a face in a moving picture aired on TV has been used in various applied fields.

Such technology is of particular utility when applied to security systems that manage access to restricted areas employing facial recognition systems instead of keys or cards or a face database search that searches for a specified person among a database of known criminals

FIG. 1A and FIG. 1B show that a frontal face shot in a photo database or a moving picture accounts for a very low percentage of samples.

FIG. 1A illustrates the result of an analysis of 12,063 face pictures downloaded off the Internet, and FIG. 1B illustrates a result of an analysis of 747 faces in moving pictures of TV broadcasts. In both experiments as shown in FIG. 1A and FIG. 1B, a frontal face shot is determined to be a face between oriented −15 ° and +15° in both vertical and horizontal axes.

Referring to FIG. 1A, frontal face shots account for 51% whereas non-frontal face shots account for 49%. The frontal face shots account for 34.7%, whereas non-frontal face shots account for 65.3% according to FIG. 1B.

It can be inferred from the results shown in FIG. 1A and FIG. 1B that the chance of acquiring a frontal face shot in real life is between 30% and 50%.

Therefore, in order to estimate a frontal face from a non-front face, it is important to acquire information as to how much the non-frontal face has rotated in comparison to the frontal face.

For example, when a face is to be analyzed using only a frontal-face-recognition device, a rotation angle of faces in different facial poses is computed and the frontal face recognition device is applied to the faces within predetermined rotation angles, to thereby execute the face recognition system.

The face-recognition device can also be applied when a rotation angle of a face in a different facial pose is computed, and the face is rotated by the same number degrees in a reverse direction, to thereby morph it into a frontal face.

When a face-recognition device is employed for each facial pose, a rotation angle of each face can be determined.

U.S. Pat. No. 6,144,755 discloses a method and an apparatus for determining a facial pose, the method comprising storing a large number of images of various subjects in different poses in a memory, and comparing an image input to a stored image associated with one parameter representing a pose, thereby determining a specific pose. However, this method and apparatus can only be applied to a specified subject as opposed to an unspecified subject and a minute, unknown rotation angle.

Therefore, a method of estimating a rotation angle of an unspecified subject in different poses is required.

### BRIEF SUMMARY

An aspect of the present invention provides an apparatus and a method for estimating a facial pose by estimating the lateral rotation angle of a subject's face employing the size ratio of a left half plane to a right half plane of the face based upon features points thereof, and a face recognition system using the method.

An aspect of the present invention provides a facial pose estimation device, an estimation method, and a face-recognition system employing the method of estimating a facial pose by detecting many feature points of a subject's face and estimating a lateral rotation angle of the face employing a size ratio of a left half plane of the face to a right half plane based upon the feature points.

According to an aspect of the present invention, there is provided a facial-pose-estimation device comprising a pre-processing module that provides feature points of a face of a received image, and a pose-estimation-module that computes sizes of a left half plane and a right half plane of the face from the provided feature points, and a lateral rotation angle of the face from the computed sizes.

According to another aspect of the present invention, there is provided a method of estimating a facial pose, the method comprising steps of: (a) providing feature points of a face of a received image, (b) computing the size of a left half plane and of a right half plane of the face from the provided feature points, and (c) computing a lateral rotation angle of the face from the calculated size ratio.

According to a further aspect of the present invention, there is provided a face recognition system comprising a face-image database that stores face images, an image-providing module that provides an image including a face image of a subject that is being searched for, a facial-pose-estimation module that computes a lateral rotation angle of a left half plane and a right half plane of the subject's face from a size ratio thereof, and an image-comparison module that rotates the face image of the subject by the same computed rotation angle in the opposite direction, and searches for an image similar to the face image of the subject.

According to a still further aspect of the present invention, there is provided a face recognition system comprises a face-image database that stores face images, an image-input module that receives the face images, a facial-pose-estimation module that computes the lateral rotation angle of the left half plane and the right half plane of the subject's face from the calculated size ratio, and an image-comparison module that rotates the face image of the subject by the same computed rotation angle in the opposite direction, and searches for an image similar to the face image of the subject.

According to yet another aspect of the present invention, there is provided a computer program product provided a program for executing the aforementioned method.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1A and FIG. 1B show that a frontal face shot in a photo database or a moving picture accounts for a very low percentage.

FIG. 2 is a block diagram illustrating a configuration of a facial-pose estimation device according to an embodiment of the present invention.

FIG. 3 is a block diagram illustrating a configuration of a first pre-processing module according to an embodiment of the present invention.

FIG. 4 is a block diagram illustrating a configuration of a second pre-processing module according to an embodiment of the present invention.

FIG. 5A to FIG. 5C illustrate images showing feature points of a face image.

FIG. 6 is a diagram illustrating a configuration of a pose-estimation module according to an embodiment of the present invention.

FIG. 7 illustrates a face image with feature points selected.

FIG. 8 illustrates a left half plane 810 and a right half plane 820 formed by connecting the representative feature points.

FIG. 9 is a drawing illustrating a method of estimating a facial pose using the previously selected feature points.

FIG. 10A to FIG. 10C illustrate measurement results according to an embodiment of the present invention.

FIG. 11 is a flowchart illustrating a method of estimating a facial pose according to an embodiment of the present invention.

FIG. 12 is a block diagram illustrating a configuration of a face recognition system according to an embodiment of the present invention.

FIG. 13 is a block diagram illustrating a configuration of a face recognition system according to an embodiment of the present invention.

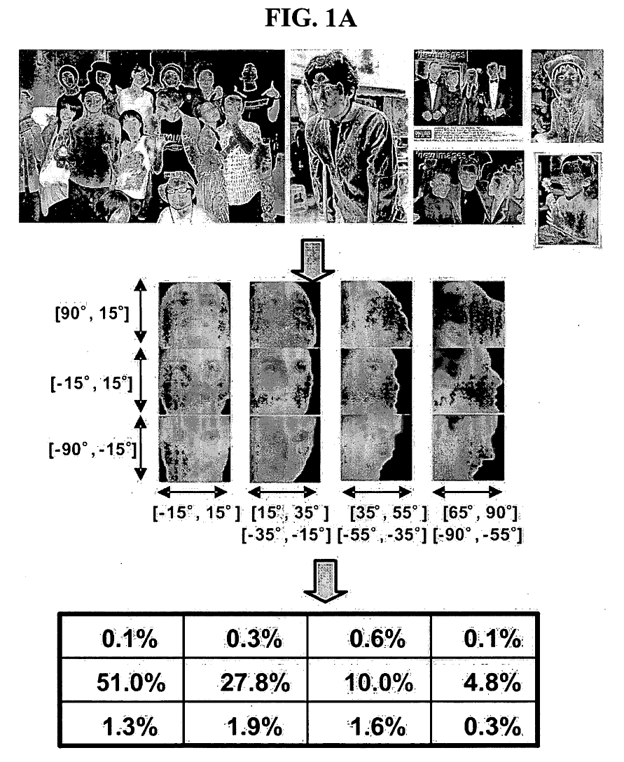

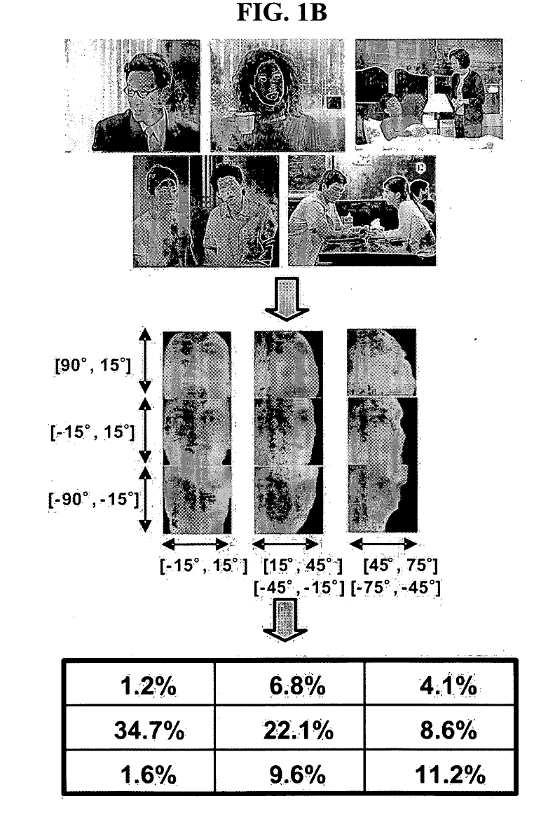

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

Embodiments of the present invention are described hereinafter with reference to flowchart illustrations of user interfaces, methods, and computer program products according to embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create averages for implementing the functions specified in the flowchart block or blocks.

These computer program instructions may also be stored in a computer-usable or computer-readable memory that can direct a computer or other programmable data processing apparatus to function in a particular manner such that the instructions stored in the computer-usable or computer-readable memory produce an article of manufacture including instruction averages that implement the functions specified in the flowchart block or blocks.

The computer program instructions may also be loaded into a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur in an order that differs from those described herein. For example, two blocks shown in succession may in fact be executed substantially concurrently or the blocks may sometimes be executed in reverse order depending upon the functionality involved.

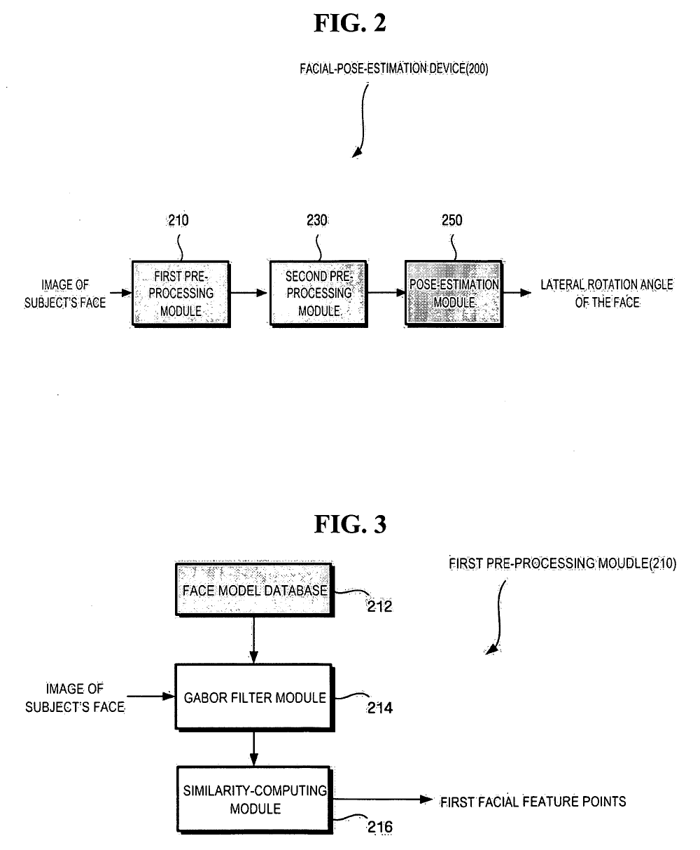

FIG. 2 is a block diagram illustrating a configuration of a facial-pose estimation device according to an embodiment of the present invention.

Referring to FIG. 2, a facial-pose-estimation device 200 receives a sample image of a subject's face, and outputs a rotated sample image. The pose-estimation device 200 comprises a first pre-processing module 210, a second pre-processing module 230, and a pose-estimation module 250.

The term “module”, as used herein, averages, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The components and modules may be combined into fewer components and modules or further separated into additional components and modules.

A first pre-processing module 210 receives an image of a sample, which may include a face image either captured with a portable image-capturing device or taken from a moving picture of a TV broadcast. In addition, the face image may have been captured by a camera lens of a system recognizing different faces or available in an image file. In other words, an image of a subject's face is assumed to be specific portions taken out from the aforementioned images.

The first pre-processing module 210 tracks local feature points of the received sample image. In an example of the present embodiment, a Gabor filter is employed in order to perform such an operation.

A face recognition method employing the Gabor filter applies a set of 2-D Gabor filters with a different frequency and a directional characteristic in a certain region of a face according to the local feature points, and recognizes the face based upon a response variable. However, employing a Gabor filter is not the only way to track local feature points. Other methods may be employed to do the same. Detailed operations carried out in a first pre-processing module 210 will be described with reference to FIG. 3.

The pre-processing module 230 acquires information on the local feature points tracked by the first pre-processing module 210, and approximates to global feature points, i.e., the pre-processing module 230 rearranges the local feature points in such a way that they fit the shape of the face, and extracts the global feature points, thereby providing information on the location of the feature points. For this, the described embodiments of the present invention track global feature points employing principal components analysis (hereinafter, referred to as “PCA”).

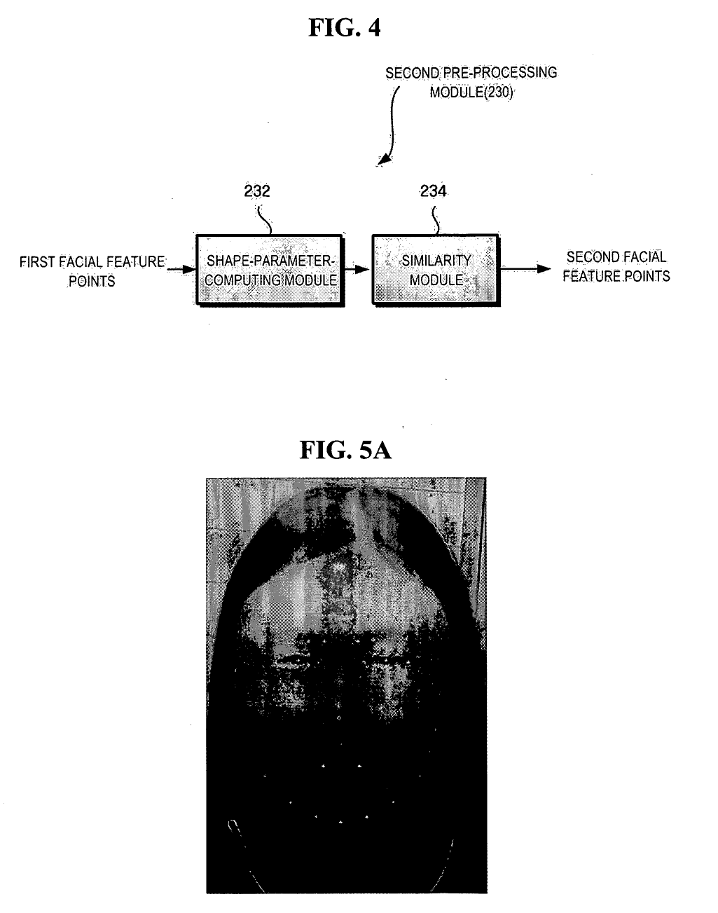

A face recognition method employing PCA recognizes a face by the overall features, not by detailed features. However, PCA is not the only way to track global feature points. Indeed, it is to be understood that the second pre-processing module 230 may employ other methods. Operations carried out in the second pre-processing device will be described in detail with reference to FIG. 4.

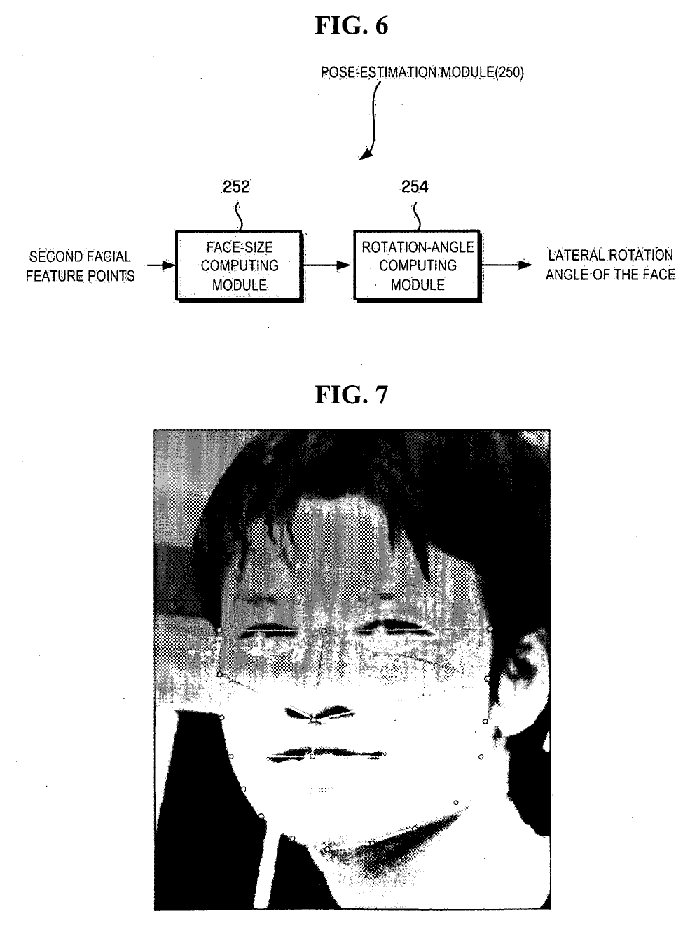

A pose-estimation module 250 computes a size ratio of a left half plane of the face to a right half plane by employing the global feature points extracted by the second pre-processing module 230, and is able to estimate a facial pose by calculating a lateral rotation angle from the size ratio. Operations carried out in the pose-estimation module 250 will be described in detail with reference to FIG. 6.

According to the present embodiment, a facial-pose estimation device 200 comprises a first pre-processing module 210, a second pre-processing unit 230, and a pose-estimation module 250; however, the facial pose can be estimated based upon the local feature points tracked by the first pre-processing module 210 via the pose-estimation module 250, bypassing the second pre-processing module 230.

FIG. 3 is a block diagram illustrating a configuration of a first pre-processing module according to an embodiment of the present invention.

Referring to FIG. 3, the first pre-processing module 210 comprises a face-model database 212, a Gabor filter module 214, and a similarity-computing module 216.

The face-model database 212 stores images of training faces which are referred to in the process of face recognition.

In order to obtain response variables, the Gabor filter module 214 applies a set of 80 Gabor wavelet filters having different directional characteristics and frequencies to each local feature point of N training images stored in the face-model database 212.

Next, the Gabor filter module 214 calculates the average feature points from the N training images, and initializes the average feature points based upon a certain part of the face of the received sample image, for example, the location of the eyes. The Gabor filter module 214 then obtains response variables of the set of Gabor wavelet filters of the average feature points, i.e. the feature points of the sample image become the average feature points.

The Gabor wavelet filter gets convoluted with predetermined feature points of the face images, to thereby compute a predetermined result value. Face recognition is done by the result value, which can be represented by:
(WI)(kⱼ,x₀)=∫Pⱼ(x−x₀)I(x)dx (1)
where Pⱼ(x−x₀) denotes a Gabor wavelet and I(x) denotes an image. Pⱼ(x−x₀) can be represented as follows.

$$\begin{matrix}{P}_{j} ( x ) = \frac{{k}_{j}^{2}}{{σ}^{2}} exp ( - \frac{{k}_{j}^{2} {x}^{2}}{2 {σ}^{2}} ) ( exp ( ⅈ {k}_{j} x ) - exp ( - \frac{{σ}^{2}}{2} ) ) \\ = \frac{{k}_{j}^{2}}{{σ}^{2}} exp ( - \frac{{k}_{j}^{2} {x}^{2}}{2 {σ}^{2}} ) \\ [ cos ( {k}_{j} x ) - exp ( - \frac{{σ}^{2}}{2} ) + ⅈ sin ( {k}_{j} x ) ]\end{matrix} \qquad ( 2 )$$

The values of v and μ can be calculated by:

$${k}_{j} = ( \begin{matrix}{k}_{jx} \\ {k}_{jy}\end{matrix} ) = ( \begin{matrix}{k}_{v} cos {φ}_{μ} \\ {k}_{v} sin {φ}_{μ}\end{matrix} )$$

$${k}_{v} = {2}^{\frac{v + 2}{2}} π , \\ {φ}_{μ} = μ \frac{π}{8} , \\ j = μ + 8 v$$

$$v = 0 , 1 , … , 4$$

$$μ = 0 , 1 , … , 7$$

where kᵥ and φ_{μ} respectively denote a frequency and a directional characteristic, and v has 5 frequencies and μ has 8 directional characteristics. The function

$$cos ( {k}_{j} x ) - exp ( - \frac{{σ}^{2}}{2} )$$

is an even function, and sin(k x) is an odd function. The magnitude and phase of the response variable can be calculated from the response variable of the even and odd functions.

The similarity-computing module 216 compares a response variable of a set of -Gabor wavelet filters of the sample image received with response variables of the N training images stored in the face-model database 212.

The similarity-computing module 216 then computes the displacement of the feature points of the sample image for every one of the feature points of the sample image, and compensates for a coordinate for the location of the feature points of the sample image to maximize the similarity to the images stored in the face model database 212.

Such similarity can be calculated from the following equation.

$${S}_{D} ( J , {J}^{′} , {d}^{->} ) = \frac{{\sum }_{j = 0}^{N} {a}_{j} {a}_{j}^{′} cos ( {ϕ}_{j} - ( {ϕ}_{j} + {d}^{->} \cdot {{k}^{->}}_{j} ) )}{\sqrt{{\sum }_{j = 0}^{N} {a}_{j}^{2} {\sum }_{j = 0}^{N} {a}_{j}^{′2}}} , \qquad ( 3 )$$

where α denotes the magnitude of a response variable, φ denotes a phase thereof, and d̅=(dₓ,d_{y}) denotes the displacement of feature points of the sample image. In addition, J denotes a response variable of a set of Gabor wavelet filters stored in the face model database 212, and J′ denotes feature points of the received sample, i.e., a response variable of the set of Gabor wavelet filters of the average feature points.

Such coordinates for the location of the feature points are referred to as “first face feature points” in the present description.

FIG. 4 is a block diagram illustrating a configuration of a second pre-processing module according to an embodiment of the present invention.

Referring to FIG. 4, the second pre-processing module 230 receives local feature points, i.e. first facial feature points, from the first pre-processing module 210, approximates them to global feature points via PCA, and provides second facial feature points via a shape parameter computing module 232 and a similarity module 234.

The shape-parameter-computing module 232 computes a shape parameter required for the approximating process.

Assuming that xⁱ represents shape information of the i^{th} image among N face images stored in the face-model database 212, xⁱ can be represented by the following equation:
xᵢ=(xᵢ₀,yᵢ₀,xᵢ₁,yᵢ₁, . . . ,xᵢₖ,yᵢₖ, . . . ,xᵢₙ₋₁,yᵢₙ₋₁)^{T}, (4)
where n=72 (number of feature points).

The average shape of the N face images can be represented by equation 5, and the deviation of average of N face images can be represented by equation 6.

$$\begin{matrix}\overline{x} = \frac{1}{N} {\sum }_{i = 1}^{N} {x}_{i} & ( 5 ) \\ {dx}_{i} = {x}_{i} - \overline{x} & ( 6 )\end{matrix}$$

A covariance matrix of the deviation can be represented by equation 7, and an eigenvalue λ can be calculated from equation 8.

$$\begin{matrix}S = \frac{1}{N} {\sum }_{i = 1}^{N} {dx}_{i} {dx}_{i}^{T} & ( 7 ) \\ {Sp}_{k} = {λ}_{k} {p}_{k} , \\ t {λ}_{k} \geq {λ}_{k + 1} \\ and \\ {p}_{k}^{T} {p}_{k} = 1. & ( 8 )\end{matrix}$$

When x′ represents shape information of a received sample image, x′ can be represented by equation 9.
x′=(x₀,y₀,x₁,y₁, . . . ,xₙ₋₁,yₙ₋₁)^{T} (9)

The deviation of each average shape of the shape information x′ and the N face images can be represented by equation 10.
dx′=x′−x (10)

An eigenvector P can be calculated from the eigenvalue calculated by equation 8, a weight b can be calculated by the eigenvector P, which is represented by the following equation:
b=P⁻¹dx′,
where b=(b₁, b₂, . . . , bₜ), bₖ satisfies −3\sqrt{λₖ}≦bₖ≦3\sqrt{λₖ} and limits the range of local feature points of the face image, bₖ is set to −3\sqrt{λₖ} if it is smaller than −3\sqrt{λₖ}. If it is bigger than 3\sqrt{λₖ}, bₖ is set to 3\sqrt{λₖ}.

Lastly, shape information, which has approximated local feature points of an image of a face to global feature points, can be represented by equation 12.
x= x̅+Pb (12)

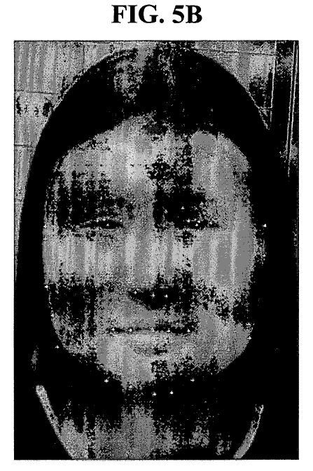

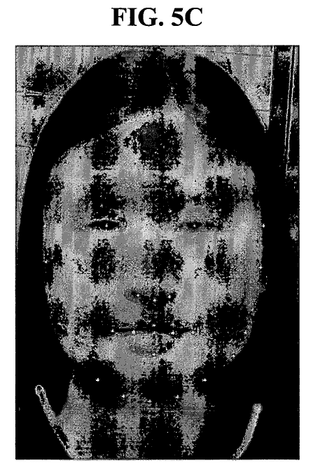

FIG. 5A to FIG. 5C illustrate images showing feature points. FIG. 5A illustrates average feature points, FIG. 5B illustrates local feature points, and FIG. 5C illustrates global feature points.

FIG. 6 is a diagram illustrating a configuration of a pose-estimation module according to an embodiment of the present invention.

Referring to FIG. 6, a pose-estimation module 250 comprises a face-size computing module 252 and a rotation-angle computing module 254.

When the first pre-processing module 210 is employed or when both the first pre-processing module 210 and the second pre-processing module 230 are employed, a normalized distance error occurring between a ground truth manually marked by a user and points automatically tracked is divided by the distance between the eyes, and can be represented as follows:
NDE(i,j)=|ADFP(i,j)−GTFP(i,j)|/L, 1≦i≦n, 1≦j≦N
where: NDE(ij) is the i^{th} normalized distance error of the j^{th} image, ADFP(ij) is the i^{th} feature point automatically located in the j^{th} image, ATFP(ij) is the i^{th} ground truth feature point in the j^{th} image, L is the distance between eyes, n is the number of the feature points, and N images.

The average normalized distance error (ANDE) can be represented by the following equation.

$$ANDE = \frac{1}{N} \frac{1}{n} {\sum }_{j = 1}^{N} {\sum }_{i = 1}^{n} NDE ( i , j )$$

A performance measurement according to the embodiment of the present invention demonstrates that the ANDE is 6.61% when the first pre-processing module 210 is employed alone. The ANDE is 4.45% when both the first pre-processing module 210 and the second pre-processing module 230 are employed. In other words, better performance can be anticipated when both modules are employed.

When a feature point is extracted via the method mentioned above, the face-size computing module 252 picks a representative feature point among others.

The representative feature points, needed to calculate the sizes of a left half plane of a face and a right half plane of the face, may advantageously comprise both plane's boundaries, i.e. centerline points and outline points. Such feature points include a feature point averaging out a feature point of the glabella, feature points of outer corners, a feature point of a tip of the nose, and a feature points around the lips.

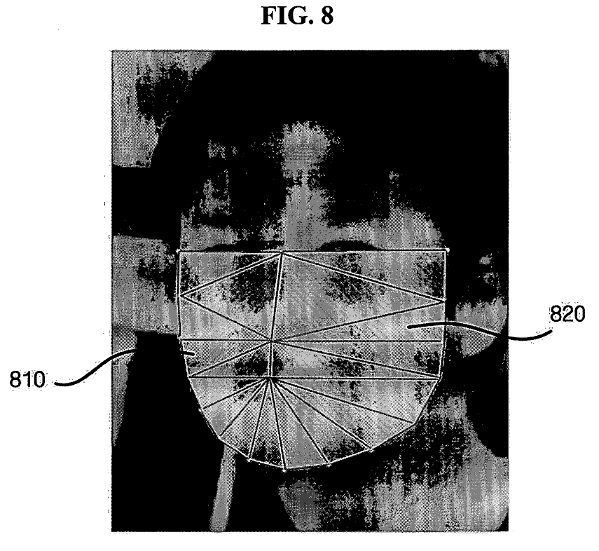

FIG. 7 illustrates a face image with feature points selected, and FIG. 8 illustrates a left half plane 810 and a right half plane 820 formed by connecting the representative feature points.

As shown in FIG. 7 and FIG. 8, triangles may be formed by connecting the representative feature points and the sizes of both planes can be calculated by a sum of the triangles.

In order to estimate a facial pose, a face-size-computing module 252 computes the sizes of a left half plane 810 and the right half plane 820, and the size ratio of the left half plane 810 to the right half plane 820. A rotation-angle module 254 is able to estimate the facial pose, i.e. the rotation angle of the face by the size ratio.

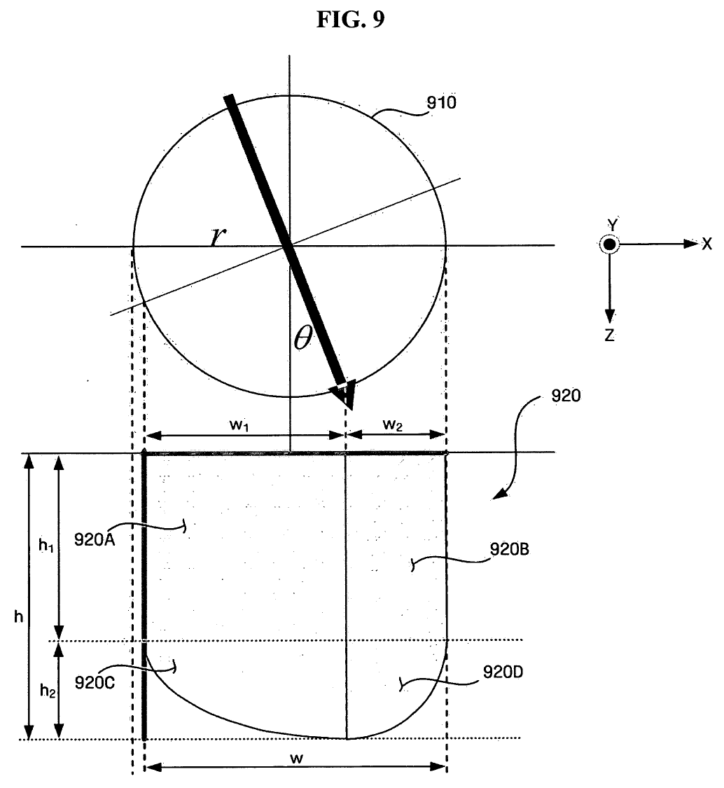

FIG. 9 is a drawing illustrating a method of estimating a facial pose using the previously selected feature points.

As shown in FIG. 9, a face of a subject is simplified to a 3-D shape cylinder in order to estimate the facial pose, and a shape viewed from an inferior direction in a transverse plane, i.e. looking down the face from the top toward the bottom, is represented by a geometrical figure such as a circle 910.

The radius of the circle 910 is a distance between a center of the head and an outer corner, and the angle θ is a rotation angle of the subject's face from a z-axis to a y-axis. For understanding, a right bound rotation from the y-axis is said to produce a positive θ, and a rotation in the opposite direction is said to produce a negative θ.

A FIG. 920 is an illustration of the face of the subject viewed from the z-axis and simplified into a 2-D figure. An outer corner of the FIG. 920 may be formed by connecting a feature point of a center of a brow and feature points on outer corners.

In addition, 920A and 920B denoting cheeks of a subject may be modeled by a square figure, and 920C and 920D denoting a chin of the subject may be modeled by a quarter of a cylinder. Regions referring to 920A and 920C correspond to the right half plane of the face viewed from the z-axis, and regions referring to 920B and 920D correspond to the left half plane of the face viewed from the z-axis.

Below is a method of computing a rotation angle of the subject's face employing a size ratio of left half planes of the face 920A and 920C to right half planes 920B and 920D when the subject's face has rotated to the right from the y-axis as illustrated in FIG. 9, i.e. 0°≦θ≦45°. In other words, a range of a facial pose is assumed to be −45°≦θ≦45° in the present embodiment.

w denotes a width of a subject's face and h denote a height of the face. In addition, w₁ denotes the width of a left half plane of the face and w₂ denote the width of a right half plane of the face. h₁ denotes the height of the cheek of the left half plane of the face or that of the right half plane, and h₂ denotes the height of the chin of the left half plane of the face or that of the right half plane.

LHP represents the size of a left half plane of a face; the LHP can be represented by:

$$LHP = {w}_{1} {h}_{1} + \frac{π}{4} {w}_{1} {h}_{2} = ( r cos θ + r sin θ ) {h}_{1} + \frac{π}{4} ( r cos θ + r sin θ ) {h}_{2} \qquad ( 13 )$$

RHP represents the size of a right half plane of a face; the RHP can be represented by:

$$RHP = {w}_{2} {h}_{1} + \frac{π}{4} {w}_{2} {h}_{2} = ( r - r sin θ ) {h}_{1} + \frac{π}{4} ( r - r sin θ ) {h}_{2} \qquad ( 14 )$$

The LHP and the RHP can be calculated by a pose-estimation module 250.

A rotation-angle-computing module 254 can compute the size ratio of a left half plane of a face to that of a right half plane, which can be represented by:

$$\frac{RHP}{LHP} = \frac{1 - sin θ}{cos θ + sin θ} = ρ \leq 1 \qquad ( 15 )$$

Equation 15 can be rearranged in order to solve for θ (See equation 16.) In other words, the rotation angle of the subject's face can be represented by:

$$θ = {sin}^{- 1} ( \frac{1}{\sqrt{{( ρ + 1 )}^{2} + {ρ}^{2}}} ) - {tan}^{- 1} ( \frac{ρ}{ρ + 1} ) \qquad ( 16 )$$

When a face of the subject has rotated counterclockwise from a y-axis, i.e. −45°≦θ≦0°, a method of computing a rotation angle of a subject's face employing a size ratio of the left half planes 920A and 920C to the right half planes 920B and 920D can be described by the following:

Let LHP represent the size of a left half plane of a face and let RHP represent the size of a right half plane; they are both defined by equations 17 and 18.

$$\begin{matrix}LHP = {w}_{1} {h}_{1} + \frac{π}{4} {w}_{1} {h}_{2} \\ = ( r + r sin θ ) {h}_{1} + \frac{π}{4} ( r + r sin θ ) {h}_{2}\end{matrix} \qquad ( 17 )$$

$$\begin{matrix}RHP = {w}_{2} {h}_{1} + \frac{π}{4} {w}_{2} {h}_{2} \\ = ( r cos θ + r sin θ ) {h}_{1} + \frac{π}{4} ( r cos θ + r sin θ ) {h}_{2}\end{matrix} \qquad ( 18 )$$

Hence, the size ratio of the left half plane to the right half plane can be calculated from equation 17 and equation 18, and is represented by equation 19.

$$\frac{RHP}{LHP} = \frac{cos θ - sin θ}{1 + sin θ} = ρ > 1 \qquad ( 19 )$$

Equation 19 can be rearranged in order to obtain θ. In other words, the rotation angle of a face of a subject can be represented by:

$$θ = {cos}^{- 1} ( \frac{ρ}{\sqrt{{( ρ + 1 )}^{2} + 1}} ) - {tan}^{- 1} ( ρ + 1 ) \qquad ( 20 )$$

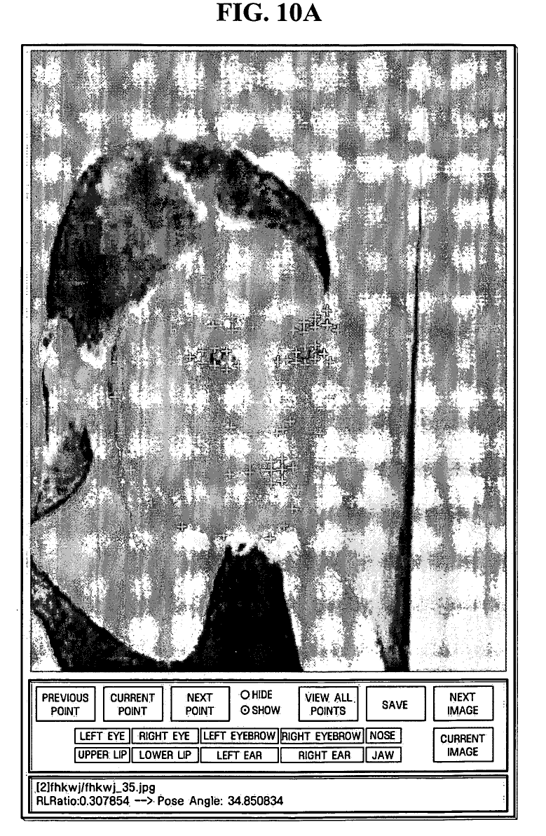

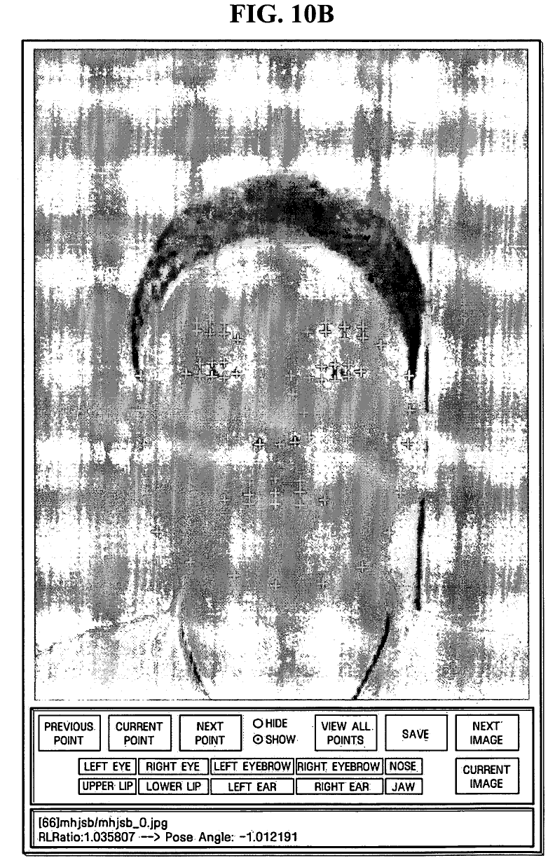

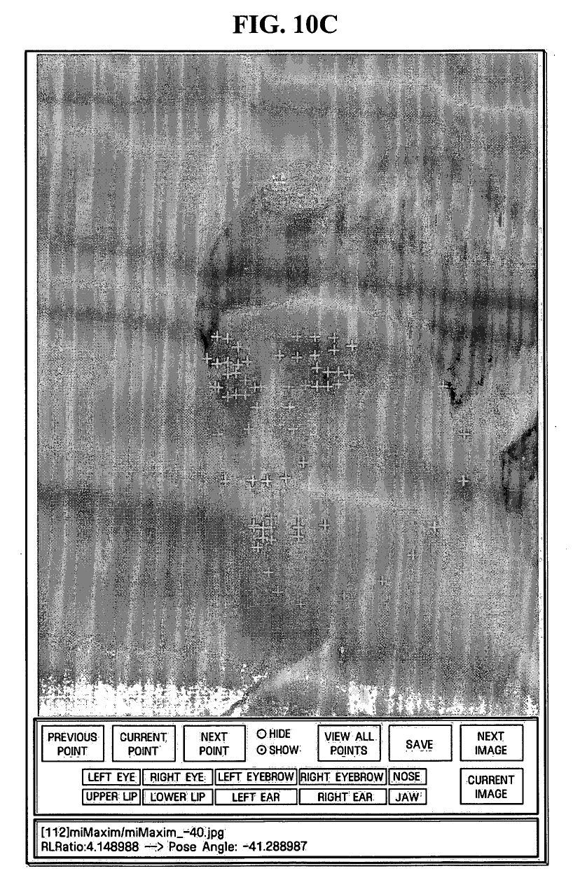

FIG. 10A to FIG. 10C illustrate measurement results according to an embodiment of the present invention.

FIG. 10A illustrates a face of a subject rotated clockwise by 35°. The measurement results according to an implementation of the present embodiment shows that the actual value of θ was 34.9°.

FIG. 10B illustrates a face of a subject looking straight forward and the result shows the actual value of θ was −1.0°. FIG. 10C illustrates a face of a subject rotated counterclockwise by −40°, but the system of the present embodiment calculated a θ of −41.3°.

Based on the measurement results as shown in FIG. 10A through FIG. 10C, it is apparent that the present embodiment is considerably accurate.

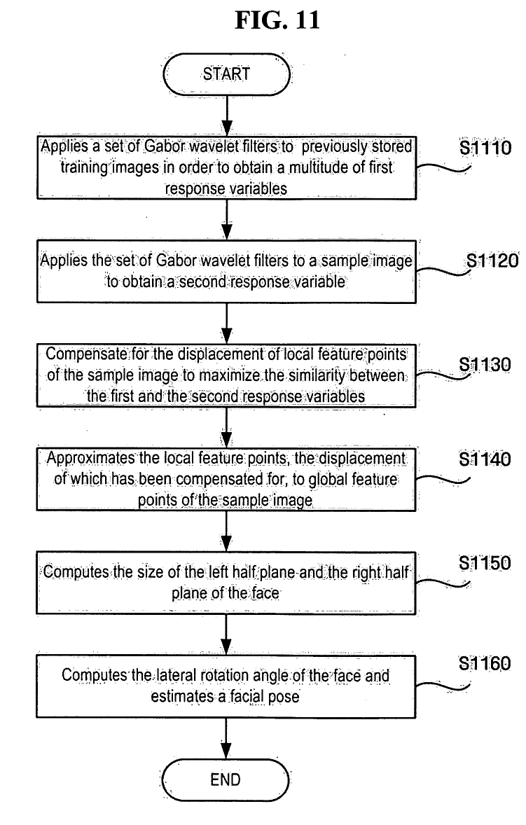

FIG. 11 is a flowchart illustrating a method of estimating a facial pose according to an embodiment of the present invention.

First, a first pre-processing module 210 in a facial-pose-estimation device 200 applies a set of Gabor wavelet filters, previously described to previously stored training images in order to obtain a multitude of (i.e., plural) first response variables S1110.

Then the first pre-processing module 210 applies the set of Gabor wavelet filters to a sample image to obtain a second response variable S1120, and maximizes the similarity between the first response variables and the second response variable in order to compensate for the displacement of local feature points of the sample image S1130.

The first pre-processing module 210 computes the average of the feature points from the previously stored training image, initializes the average feature point based upon a certain portion of the face extracted from the sample image, e.g. the position of the eyes, and obtains the second variable of the set of Gabor wavelet filters from the average feature point.

The second pre-processing module 230 approximates local feature points, the displacement of which has been compensated for, to global feature points of the sample image as in S1140, and a pose-estimation-module 250 computes the size of the left half plane and the right half plane of the face based upon the approximated feature points as in S1150 and computes the size ratio in order to compute the lateral rotation angle of the face of the sample image, to thereby estimate a facial pose as in S1160.

In measurements according to the present embodiment, an angle error (AE) refers to an error between a ground truth and an angle found automatically, and can be represented by:
AE(i,j)=|ADPA(i,j)−GTPA(i,j)|,
where 1≦i≦n, 1≦j≦N, AE(i,j) is the j^{th} image of an error at the i^{th} angle, ADPA(i,j is the rotation angle of the i^{th} feature point automatically detected in the j^{th} image, GTPA(i,j) is the rotation angle of the i^{th} ground truth feature point in the j^{th} image, n is the number of feature points, and N is the number of images.

The average angle error (AAE) can be represented as follows:

$$AAE = \frac{1}{N} \frac{1}{n} {\sum }_{j = 1}^{N} {\sum }_{i = 1}^{n} AE ( i , j )$$

The result of the performance measurement according to the implementation of the present invention shows that an AAE is recorded to be 3.36°, which is considerably accurate.

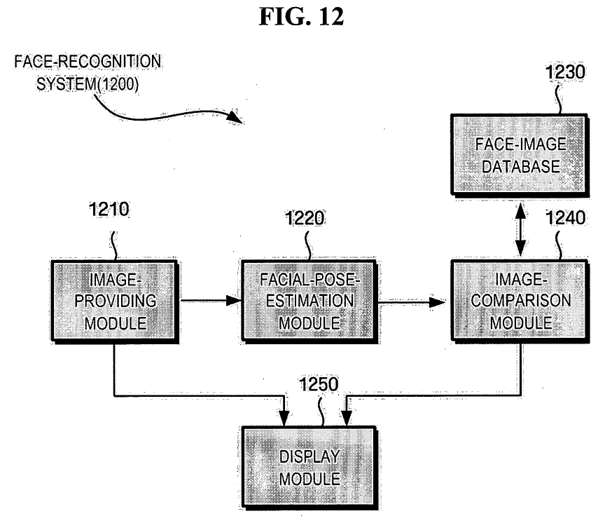

FIG. 12 is a block diagram illustrating a configuration of a face recognition system according to an embodiment of the present invention.

FIG. 12 illustrates the face recognition system designed for a face database search such as a criminal search where a specified person is searched for among a large number of unspecified people: the system comprises an image-providing module 1210, a facial-pose-estimation module 1220, an image-comparison module 1240, a face-image database 1230, and a display module 1250.

The image-providing module 1210, which provides an image including a face of a subject being searched for, may comprise different kinds of wired/wireless storage media or network interfaces. The facial-pose-estimation module 1220 receives the provided image and computes the lateral rotation angle of the left half plane and that of the right half plane of the face employing a size ratio thereof, and provides the rotation angle to the image-comparison module 1240. Then, the image-comparison module 1240 rotates the image by the rotation angle computed in a reverse direction of, and searches for a face similar thereto.

An image provided through the image-providing module 1210 or searched for from the face-image database 1230 through the image-comparison module 1240 can be provided to a user.

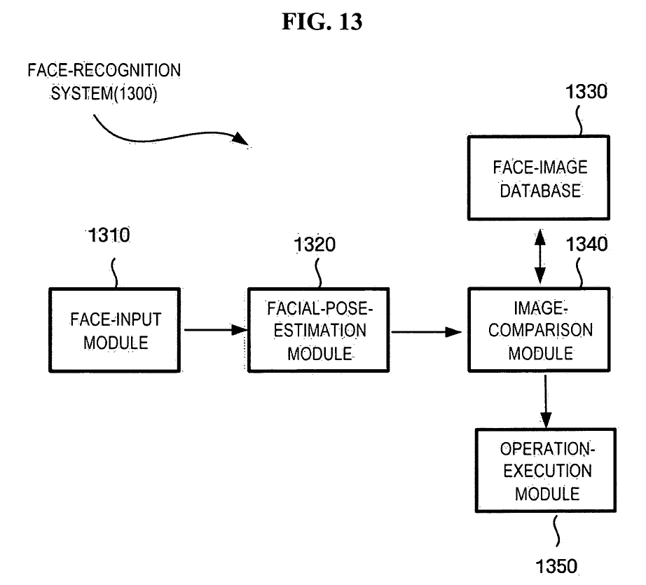

FIG. 13 is a block diagram illustrating a configuration of a face recognition system according to an embodiment of the present invention.

FIG. 13 illustrates a security system administering access to restricted areas by employing facial features instead of keys or cards to identify an individual the system comprises a face-input module 1310, a facial-pose-estimation module 1320, a face-image-comparison module 1340, a face-image database 1330, and an operation-execution module 1350.

The image-input module 1310 refers to various capturing devices comprising a camera lens. The facial-pose-estimation module 1320 computes a lateral rotation angle of the face received according to the method previously described and provides it to the image comparison module 1340, which then rotates the image by the same rotation angle computed in the reverse direction, and searches for a matching image in the face image database 1330. Here, the word “match” does not mean identical, but it means similar within a small error.

If an image matching the face image provided from the image-comparison module 1340 is found, the operation-execution module 1350 executes operations such as opening or shutting a gate.

Embodiments of the present invention provide a method of accurately computing a lateral rotation angle of a face of a received image.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A facial-pose-estimation device comprising:
a pre-processing module that provides feature points of a face of a received image; and
a pose-estimation-module that computes sizes of a left half plane and a right half plane of the face from the provided feature points, and a lateral rotation angle of the face from the computed sizes.

2. The device of claim 1, wherein the pre-processing module includes a first pre-processing module that provides local feature points.

3. The device of claim 2, wherein the first pre-processing module includes:
a face-model database that stores training images referred to in a face recognition process;
a Gabor filter module that obtains first response variables by applying a set of Gabor wavelet filters to feature points of at least two stored training images, and a second response variable by applying the set of Gabor wavelet filters to the feature points of the face of the received image; and
a similarity-computing module that compensates for displacement of the feature points of the face of the received image to maximize a similarity between the first response variables and the second response variable, and provides the feature points.

4. The device of claim 3, wherein the feature points of the face of the received image are equal to the average feature points of the at least two stored training images.

5. The device of claim 2, wherein the pre-processing module further comprises a second pre-processing module that approximates the provided local feature points to global feature points.

6. The device of claim 5, wherein the second pre-processing module approximates the provided local feature points to the global feature points by extracting parameters of a face shape model via principal components analysis (PCA).

7. The device of claim 1, wherein the post estimation module includes:
a face-size-computing module that extracts representative feature points delineating boundaries of the face from the provided feature points and shapes the face into a 2-D figure using the extracted representative feature points, to thereby compute the sizes of a left half plane and a right half plane of the face; and
a rotation-computing module that computes a lateral rotation angle of the face from the calculated size ratio.

8. The device of claim 7, wherein the face-size-computing module shapes a cheek region into a square and a chin region into a quarter of cylinder.

9. The device of claim 7, wherein the calculated size ratio is represented by a function of the lateral rotation angle.

10. A method of estimating a facial pose, comprising:
(a) providing feature points of a face of a received image;
(b) computing sizes of a left half plane and a right half plane of the face from the provided feature points; and
(c) computing a lateral rotation angle of the face from the calculated size ratio.

11. The method of claim 10, wherein operation (a) includes providing local feature points.

12. The method of claim 11, wherein the providing local feature points includes:
(a) applying a set of Gabor wavelet filters to feature points of at least two stored training images referred to in a face recognition process, and obtaining first response variables;
(b) applying the set of Gabor wavelet filters to the feature points of the face of the received image;
(c) compensating for displacement of the feature points of the face of the received image to maximize a similarity between the first response variables and the second response variable; and
(d) providing the compensated feature points.

13. The method of claim 12, wherein the feature points of the face are equal to the average of the feature points of the at least two stored training images.

14. The method of claim 11 further comprising approximating the local feature points to global feature points.

15. The method of claim 14, wherein the approximating local feature points to global feature points includes approximating the provided local feature points to global feature points by extracting parameters of the face shape model via principal components analysis (PCA).

16. The method of claim 10, wherein operation (b) includes:
extracting representative feature points delineating boundaries of the face;
shaping the image of the face of the received image into a 2-D figure; and
computing sizes of a left half plane and a right half plane of the face of the 2-D figure.

17. The method of claim 16, wherein the shaping the image into the 2-D figure includes shaping a cheek region into a square figure and a chin region into a quarter of cylinder.

18. The method of claim 10, wherein the calculated size ratio is represented by the function of the lateral rotation angle used in operation (c).

19. A face recognition system comprising:
a face-image database that stores face images;
an image-providing module that provides an image including a face image of a subject that is being searched for;
a facial-pose-estimation module that computes a lateral rotation angle of a left half plane and a right half plane of the subject's face from a size ratio thereof; and
an image-comparison module that rotates the face image of the subject by the computed rotation angle in the opposite direction, and searches for an image similar to the face image of the subject.

20. The system of claim 19 further comprising a display module that displays an image provided by the image providing-module or a face image found in the face-image database by the image-comparison module.

21. A face recognition system comprising:
a face-image database that stores face images;
an image-input module that receives the face images;
a facial-pose-estimation module that computes the lateral rotation angle of the left half plane and the right half plane of the subject's face from the calculated size ratio; and
an image-comparison module that rotates the face image of the subject by the computed rotation angle in the opposite direction, and searches for an image similar to the face image of the subject.

22. The system of claim 21 further comprising an operation-execution module that executes an operation when a face image found in the face image database matches the face image provided by the image-comparison module.

23. A computer program product providing a program executing a method of estimating a facial pose, the method comprising:
providing feature points of a face of a received image;
computing sizes of a left half plane and a right half plane of the face from the provided feature points; and
computing a lateral rotation angle of the face from the calculated size ratio.

24. The computer program product of claim 23, wherein the providing includes providing local feature points, by:
applying a set of Gabor wavelet filters to feature points of at least two stored training images referred to in a face recognition process, and obtaining first response variables;
applying the set of Gabor wavelet filters to the feature points of the face of the received image; and
compensating for displacement of the feature points of the face of the received image to maximize a similarity between the first response variables and the second response variable.

25. The computer program product of claim 24, wherein the Gabor wavelet filter is convoluted with predetermined feature points of the face images, to thereby compute a predetermined result value definable by:
(WI)(kⱼ,x₀)=∫Pⱼ(x−x₀)I(x)dx,
wherein Pⱼ(x−x₀) denotes a Gabor wavelet, I(x) denotes an image, and Pⱼ(x−x₀) is definable by:
$$\begin{matrix}{P}_{j} ( x ) = \frac{{k}_{j}^{2}}{{σ}^{2}} exp ( - \frac{{k}_{j}^{2} {x}^{2}}{2 {σ}^{2}} ) ( exp ( ⅈ {k}_{j} x ) - exp ( - \frac{{σ}^{2}}{2} ) ) \\ = \frac{{k}_{j}^{2}}{{σ}^{2}} exp ( - \frac{{k}_{j}^{2} {x}^{2}}{2 {σ}^{2}} ) [ cos ( {k}_{j} x ) - exp ( - \frac{{σ}^{2}}{2} ) + i sin ( {k}_{j} x ) ] ,\end{matrix}$$
wherein the values of v and μ are definable by:
$${k}_{j} = ( \begin{matrix}{k}_{jx} \\ {k}_{jy}\end{matrix} ) = ( \begin{matrix}{k}_{v} cos {φ}_{μ} \\ {k}_{v} sin {φ}_{μ}\end{matrix} ) , and$$
$${k}_{v} = {2}^{- \frac{v + 2}{2}} π , {φ}_{μ} = μ \frac{π}{8} , j = μ + 8 v$$
$$v = 0 , 1 , … , 4$$
$$μ = 0 , 1 , … , 7$$
wherein kᵥ and φ_{μ} respectively denote a frequency and a directional characteristic, v has 5 frequencies and μ has 8 directional characteristics.
